(19) United States
(12) Patent Application Publication
(10) Pub. No.: US 2013/0327141 A1
(43) Pub. Date: Dec. 12, 2013

(54) MULTIFUNCTION SENSING SYSTEM FOR USE WITH DEVICES EMPLOYING COMBUSTION OR BURNING

(71) Applicants: Franklin B. Floyd, JR., Shaker Heights, OH (US); Valentino Di Giovanni, Utopia (CA)

(72) Inventors: Franklin B. Floyd, JR., Shaker Heights, OH (US); Valentino Di Giovanni, Utopia (CA)

(73) Assignee: Franklin B. Floyd, JR., Shaker Heights, OH (US)

(21) Appl. No.: 13/494,203

(22) Filed: Jun. 12, 2012

(51) Int. Cl. G01N 19/00

(52) U.S. Cl. 73/335.02

(57) ABSTRACT

A monitoring system for use with electrically operated devices such as portable combustion heaters and having a carbon monoxide sensor, a relative humidity sensor and a supply voltage sensor and controller in a common enclosure mountable on the heater or alternatively in proximity. A user interface provides an indication of the sensor measurements which is readily discernible to persons in proximity to the system. The user interface may provide digital readouts, analog voltage outputs, serial data or logic level outputs. The system provides an alarm or disable the heater in response to one of the sensors measuring a predetermined level of sensed humidity, carbon monoxide or humidity.

### BACKGROUND

The present disclosure relates to monitoring systems for electrically operated devices such as, for example, electrically operated combustion heaters and particularly portable combustion heaters used on construction sites for maintaining climatic control in closed regions and for enhancing the curing of concrete. Such heaters have also found wide spread usage at sporting contests for providing warmth to players benches along the sidelines of the field of contest. Portable combustion heaters are typically fueled by bottled gas such as propane.

In particular, such portable combustion heaters may, if not operating properly, create a concentration of carbon monoxide (CO) sufficient to create a hazard to those persons in the vicinity of the heater. Thus, it has been desired to provide for monitoring the CO levels in the vicinity of such a heater. Additionally, where the combustion is electrically controlled, such as, for example, an electrically operated igniter or electrically controlled fuel flow valve, substantial reductions in the line or operating voltage to the electrically controlled components can affect the combustion to create hazardous levels of CO. Thus, it has been desired to provide a way or means of monitoring line voltage and providing an easily discernable indicia of the voltage to persons in the vicinity of the heater.

Where such portable combustion heaters are employed for enhancing and curing of concrete, it is desired to discontinue the heater operation when the concrete has reached a predetermined level of curing. In this regard, it has been found that the desired level of curing of the concrete may be detected by a noticeable drop in the relative humidity in the vicinity of the concrete pour. It has been desired to provide an indication of the humidity which is readily discernable to persons in the vicinity of the heater.

Thus, it has been desired to provide monitoring of humidity, carbon monoxide and power supply or line voltage at the site of an electrically operated device such as a combustion heater and to provide indication to persons in the vicinity thereof the values of the monitored characteristics. Where any of the monitored characteristics reach an unacceptable or hazardous operational level, it has been desired to provide automatic notification or alarming such that the operator of the device or persons working in proximity to the heater may take appropriate corrective action such as shutting down the heater.

### SUMMARY

The present disclosure describes a unique compact monitoring system for electrically operated devices such as electrically operated portable combustion heaters and provides monitoring of carbon monoxide level, relative humidity and power supply or line voltage and provides an in situ visual indication thereon of the monitored levels such that persons in proximity to the heater are constantly made aware of the values of the monitored characteristics. The system of the present disclosure employs the carbon monoxide sensor, a relative humidity sensor and a line or power supply voltage sensor disposed in a common enclosure which may be mounted remotely or mounted on the heater and which has a user interface which displays the levels of the monitored characteristics in a readily discernible manner. In one version, the monitored characteristics are displayed in a manner which appears to be concurrent; and, in another version the monitored characteristics sequentially for a predetermined time. In another version, the monitored characteristics are each displayed periodically at a predetermined interval. The system is designed to operate from the power supply for the electrical controls of the combustion heater; and, the system includes its own voltage regulated direct current power supply for providing power to microprocessors which are operable to interrogate measured levels of the characteristics from the sensors. The system of the present disclosure is intended to be attached as a module to existing combustion heaters to thereby provide additional safety of operation without the need to modify the construction of the heater.

The system of the present disclosure may also be connected to a relay for disabling power to the combustion heater in the event any of the monitored characteristics reach a predetermined level deemed inoperable or hazardous. Alternatively, the present monitoring system can actuate an alarm or cut off power to the heater when the line voltage is less than about 50 volts. Similarly, the system can provide an alarm when the relative humidity has dropped to about 50% or, alternatively, activate a relay to disable power to the heater. The system of the present disclosure can typically provide an alarm or shut down the heater when an average level of carbon monoxide of 50 ppm for 8 hours or 200 ppm for 1 minute are measured by the sensors. Optionally, if desired, the system of the present disclosure can provide serial data output or an analog output of 0-10 volts or 0-1 volt or 4-20 milliamps or a logic level output.

### BRIEF DESCRIPTION OF THE DRAWINGS

FIG. 1 is a perspective view of an electrically operated combustion heater of the portable type employed on construction sites with the monitoring system of the present disclosure attached thereto;

FIG. 2 is an enlarged view of a user interface of the system of FIG. 1;

FIG. 3 is a diagram of the microprocessor controller portion of the circuitry for the system of FIG. 1;

FIG. 4 is a circuit schematic of the humidity sensor portion of the circuitry of the system of FIG. 1;

FIG. 5 is a circuit schematic of the CO sensor portion of the circuitry of the present system;

FIG. 6 is a circuit schematic of the power supply portion of the circuitry of the present system;

FIG. 7 is a circuit schematic of a cut off relay for the system of FIG. 1;

FIG. 8 is a diagram of the solid state driver for the user interface of the present system;

FIG. 9 is a schematic of the digital readout exemplary user interface of the system of the present disclosure; and,

FIG. 10 is a circuit schematic of a power condition indicator for the system of FIG. 1.

### DETAILED DESCRIPTION

Referring to FIG. 1, a typical portable electrically operated combustion heater of the type employed at construction sites is illustrated generally at 10. As is well known, heaters of this type are fueled by a supply of gas such as bottled propane. An illustration of the fuel source has been omitted in FIG. 1. A burner assembly (not shown) is in a housing 12 which is typically mounted on a frame or chassis 14 with wheels 16 for the convenience of portability. In the heater 10 of FIG. 1, combustion air enters through a filter 18 and heated air from fuel combustion is discharged by a fan 22 at the end 20 of the heater.

The monitoring system of the present disclosure indicated generally at 30 is enclosed in a housing or enclosure 32 which is attached to the exterior of the burner housing 12 and has a power cord 34 provided thereon for connection to an external source of electric power as, for example, a line voltage supply of 120 volts ac 60 cycle. The power cord may also be connected to supply electrical power to the controls (not shown) for the burner and the fan 22 disposed within the burner housing 12. Although the monitoring device 30 is shown in FIG. 1 as attached to heater 10, it will be understood that the monitor 30 may be mounted separately in proximity to the heater 10.

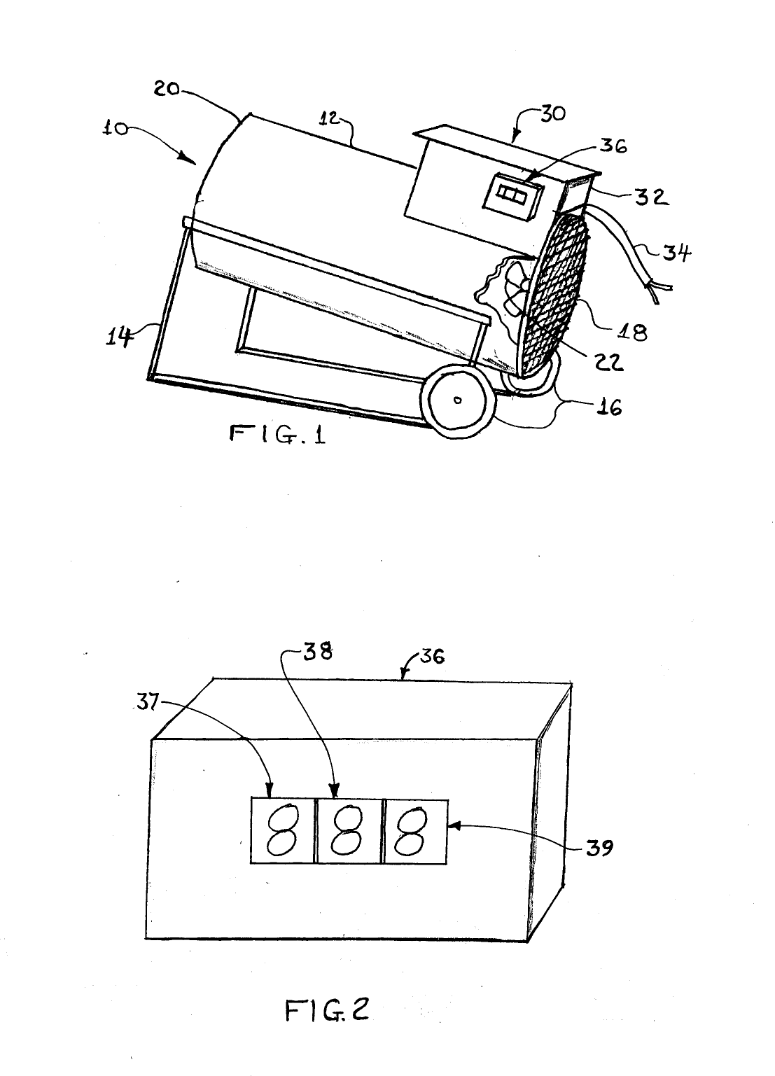

The monitoring system 30 includes a user interface indicated generally at 36 shown in enlarged detail in FIG. 2 which has digital readouts provided on the exterior thereof to give indication of the characteristics measured by the monitoring system in a manner relatively discernable by persons in proximity to the heater 10. In the present practice, the digital readout is provided by an LED display with three separate readouts 37, 38, 39, each an alpha numeric character to provide indications of relative humidity, CO and Vac level.

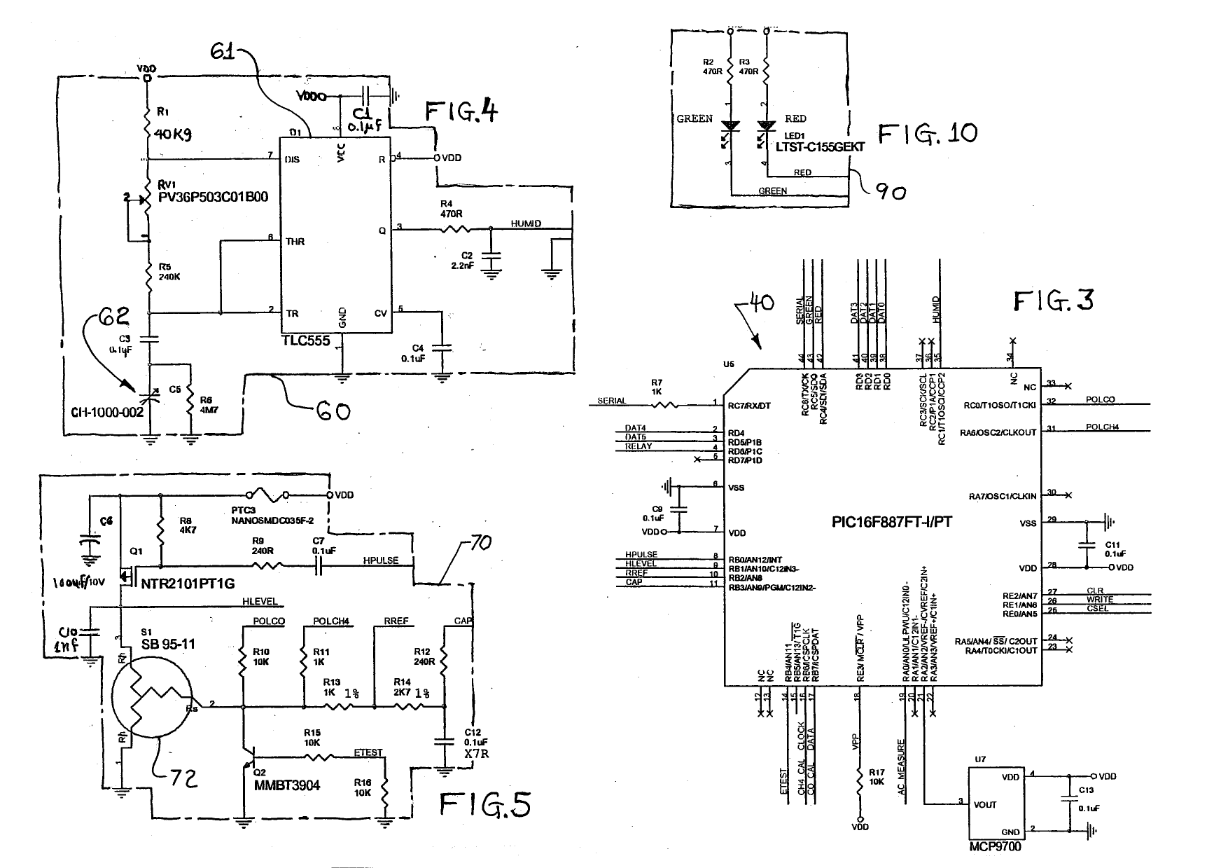

Referring to FIG. 6, a power supply circuit is indicated generally at 50 where line voltage is input through a fuse PTC1 to the primary coil of a transformer T1 and also through diode D1 and R18 to pin 19 of a microprocessor 40 (see FIG. 3) for ac line voltage measurement. The secondary coil of transformer T1 is connected through diodes D3, D4, D5 and D6 comprising a rectifying network which outputs 12 volts to a voltage regulator device which provides 5 volts dc output as VDD. The voltage on the primary coil of T1 is tapped through D1 and R18 and measured by microprocessor 40.

Referring to FIG. 3, the microprocessor controller for the system of the present disclosure is indicated generally at 40 and, in the present practice, it has been found satisfactory to employ a PIC16F887FT-1/PT device for sending and receiving signals from the sensors and calibrating and storing the calibrations and conversions from the sensor signals to the digital readout at the user interface. The microprocessor 40 receives ac line voltage at pin 19 for monitoring and provides pulse output at pin 3 to the CO sensor (as will hereinafter be described) and receives a signal at pins 31, 32 from the humidity sensor (as will hereinafter be described).

Referring to FIG. 4, the circuit for the relative humidity sensor is indicated at 60 and has a solid state timing device 61 which in the present practice may be a device of the type TLC555 and provides the timing signal output through pin 7 thereof to calibration resistor RV1 and through R5 to a humidity sensor indicated generally at 62 which, in the present practice, may comprise a Honeywell CH-1000-002 variable capacitance device. The sensor 62 provides signals through pins 2 and 8 of the device 61 which provides a humidity output signal 3R4 to pin 35 of the microprocessor 40.

Referring to FIG. 5, the circuit for the CO sensor is indicated generally at 70 where the microprocessor provides a pulse output from pin 8 thereof through R9 to Q1 of circuit 10 which, in the present practice, may comprise an NTR2101PT1G device which provides a signal to the heater element within sensor S1 through pin 3 thereof. In the present practice, S1 is a semiconductor type carbon monoxide sensor. In the present practice, a SB95-11 carbon monoxide sensor has been satisfactorily employed; however, other suitable semiconductor carbon monoxide sensor devices may also be employed. In the present practice, the pulses in the microprocessor comprise the equivalent of 0.9 Vdc for 5 seconds and about 0.2 Vdc for 15 seconds. The sensor S1 provides signals through pin 2 thereof to R10 and R11 which provide signals pins 31 and 32 of the microprocessor 40. The calibration data from the carbon monoxide sensor S1 is inputted through RREF in circuit 70 to the microprocessor at pin 17 thereof.

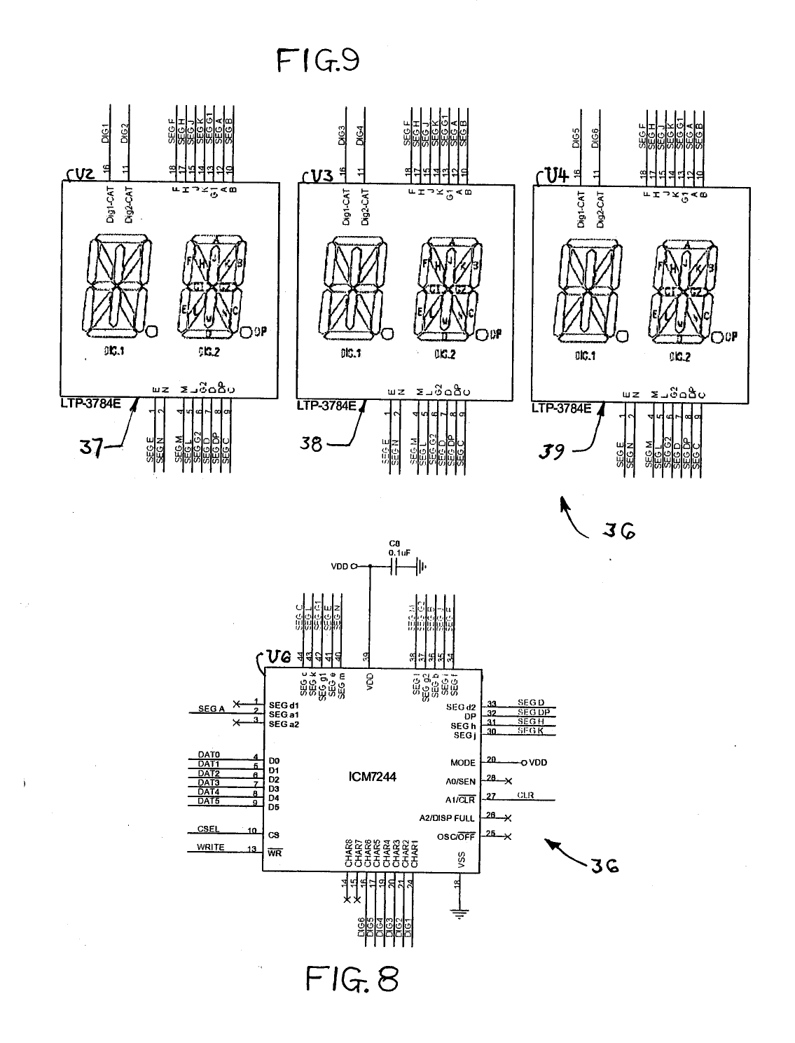

Referring to FIG. 8, an ASIC driver device U6, which in the present practice may comprise a ICM 7244 ASIC device, is illustrated for the user interface 36 and is powered with VDD through pin 39 thereof and receives digital data from the microprocessor 40 through pins 4-9 thereof and is operative to format the outputs necessary to drive the LEDs employed in digital display devices U2, U3, U4 illustrated in FIG. 9 which provide indication of the functions of 37, 38, 39. The ASIC device U6 provides outputs from pins 30-33, 34-38 and 40-44 thereof to the corresponding pins 1-9 of each of the devices U2, U3, U4. The driver is operative to send a “select” signal sequentially or serially to cause illumination of the respective devices U2, U3, U4 with the respective appropriate monitored function level. In the present practice, the cycle time or dwell period between the sequential illuminations of U2, U3, U4 is a sufficiently short interval so that it is perceived by a person viewing the display, that the three devices are concurrently illuminated.

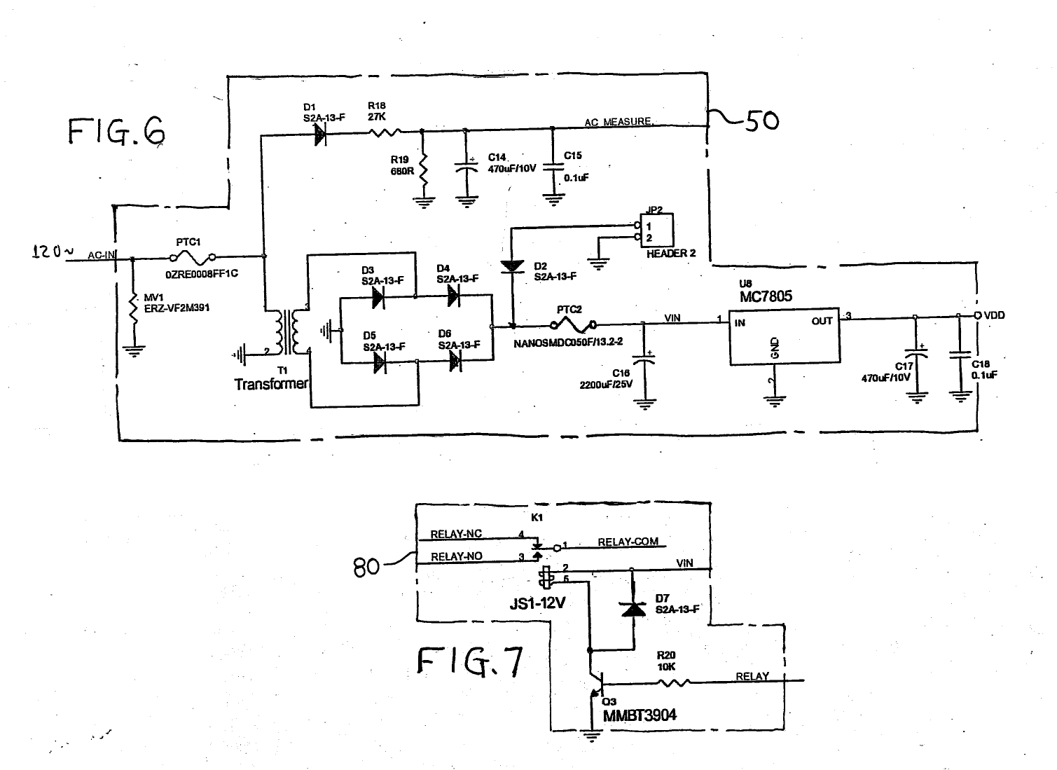

Referring to FIG. 7, a relay circuit is indicated at 80, where a signal is received at R20 from pin 4 of the microprocessor 40 and is operative to cause the coil of a relay device, which may comprise a JS1-12V relay to move the contacts K1 thereto from the normally closed to the normally open condition. The relay contacts K1 include normally closed and normally open contacts at terminals 3 and 4 thereof connected to the power line for the heater 10 such that, upon receipt of a signal through R20 and the switching device Q3 which in the present practice may comprise an MMBT3904 device, power is cut off and the heater is disabled.

Referring to FIG. 10, a power condition indicator circuit is shown at 90 wherein a dual red and green device LED1 has the base leads thereof connected to pins 42, 43 respectively of the microprocessor. In the present practice, the device LED1 may comprise an LTST-C155GEKT device which is operative to indicate power “on” with illumination in the green LED mode and to indicate an alarm with illumination in the red LED mode; and, when both the red and green LED modes are energized, the LED is operative to give an amber indication.

Alternatively, displays 37, 38, 39 may be operated to sequentially display only one of the monitored characteristics for a time interval to provide awareness to the viewer as, for example, indicating AC voltage for five seconds followed by a five second indication of CO level followed by a five second indication of relative humidity and utilizing a period of about 90 seconds to stabilize before another indication of the monitored characteristics.

In the present practice, the CO monitor undergoes a three point calibration with actual carbon monoxide gas to give an alarm in the event of a concentration of 50 ppm over eight hours, 200 ppm over 1 minute.

Alternatively, if desired, the digital readouts of FIG. 9 may be omitted and the microprocessor may output an analog signal of about 4-20 milliamps in a range of 0-1 volt or, alternatively, 0-10 volts. If desired, alternatively, a direct serial data or a logic level output may be provided by the microprocessor 40. In the present practice, it has been found desirable to provide an alarm indication or activate the relay to disable the heater if the line voltage drops below 50 volts rms. Additionally, in the present practice, it has been found satisfactory to provide alarm indication or activate the relay to disable the heater if the relative humidity drops below 50%.

The present disclosure thus describes a unique monitoring system which includes in a common enclosure, with a user interface providing a digital readout from individual sensors monitoring relative humidity, power supply or line voltage and carbon monoxide. Alternatively, serial sensor data may be outputted. The enclosure is configured to the attached to an electrically operated portable combustion device or other device for which it is desired to monitor these three characteristics but the disclosed monitoring system may be mounted remotely. The system of the present disclosure is operative to provide digital indications of the level of the monitored functional characteristics and may also activate an alarm or control function such as activate a relay to cut off power to the electrically operated device in the event that any of the monitored characteristics reaches a predetermined unsatisfactory level.

The exemplary versions have been described with reference to the drawings. Obviously, modifications and alterations will occur to others upon reading and understanding the preceding detailed description. It is intended that the exemplary versions be construed as including all such modifications and alterations insofar as they come within the scope of the appended claims.

1. A monitoring device for an electrically operated portable device employing combustion comprising:
(a) a carbon monoxide (CO) sensor and a humidity sensor;
(b) a controller operably connected to the CO sensor and the humidity sensor;
(c) a power supply operable upon connection to a source of electrical power to provide an operating voltage to the controller; and,
(d) a user interface, wherein the controller is operative to interrogate the CO sensor and humidity sensor for respectively values of CO level, voltage and relative humidity and provide an indication of the values at the user interface; and,
a power supply voltage monitor operatively connected to the controller, wherein the controller is operative to provide at the user interface an indication of voltage of the source of electrical power.

2. The device defined in claim 1, further comprising a switching device series connected to the source of electrical power and the controller, wherein the controller is operative, upon receiving a predetermined value from one of (a) the CO sensor, (b) the humidity sensor to one of (i) cause the switching device to disable the portable electrically operated device, (ii) provide an alarm signal, (iii) provide serial data output and (iv) provide a logic level output.

3. The device of claim 1, wherein the CO sensor, humidity sensor, power supply, controller and user interface are disposed proximate the portable electrically operated device employing combustion.

4. The device defined in claim 1, wherein the controller is operative to periodically interrogate the CO sensor and humidity sensor.

5. The device of claim 1, further comprising a line voltage monitor operatively connected to the controller, wherein the controller is operative to periodically interrogate the CO sensor, the humidity sensor and the voltage monitor.

6. The device of claim 5, wherein the periodic interrogation is performed sequentially.

7. The device of claim 1, wherein the controller includes a microprocessor.

8. The monitoring device of claim 1, wherein the user interface and controller are disposed remotely from the electrically operated device.

9. The monitoring device of claim 1, wherein the portable electrically operated device comprises an electrically operated combustion heater.

10. The monitoring device of claim 9, wherein the combustion heater comprises a portable construction site heater.

11. A monitoring device for an electrically controlled portable combustion device comprising:
(a) a carbon monoxide sensor;
(b) a humidity sensor;
(c) a controller connected to receive outputs from the CO sensor and the humidity sensor, wherein the controller upon connection to a source of electrical power, is operative to disable the portable electrically controlled portable combustion device in response to a predetermined level of output of one of (a) the CO sensor and (b) the humidity sensor.

12. The device of claim 11, further comprising a voltage monitor operative to measure the voltage of the source of electrical power and provide an indication thereof to the controller.

13. The device of claim 12, wherein the controller is operable in response to a predetermined measured voltage to disable the electrically controlled portable combustion device.

14. The device of claim 13, wherein the predetermined measured voltage is less than about 50 volts RMS a.c.

15. The device of claim 11, wherein the predetermined level of output of the CO sensor represents a level of one of (a) 50 ppm averaged over eight hours and (b) 200 ppm averaged over one minute.

16. The device of claim 11, wherein the predetermined level of output of the humidity sensor represents a relative humidity of about fifty percent (50%).

17. The device of claim 11, wherein the CO sensor, humidity sensor, and controller are disposed proximate the electrically operated device.

18. The device of claim 11, wherein the CO sensor, humidity sensor, and controller are disposed remotely from the electrically operated device.

19. A method of controlling an electrically operated portable combustion device comprising:
(a) providing a carbon monoxide (CO) sensor, a humidity sensor and a voltage sensor;
(b) connecting a controller to receive signal outputs from the CO sensor, the humidity sensor and the voltage sensor;
(c) connecting a switching device to the controller and the electrically operated device; and,
(d) disabling the portable combustion device in response to a predetermined signal output from one of the CO sensor, the humidity sensor and the voltage sensor.

20. The method of claim 19, further comprising disposing the CO sensor, humidity sensor, and controller proximate the heater.

21. The method of claim 19, further comprising disposing the CO sensor, humidity sensor, and controller remotely from the device.

22. The method of claim 19, further comprising disposing the CO sensor, humidity sensor and controller in a common enclosure.

23. The method of claim 22, further comprising a voltage monitor in the common enclosure.

24. The method of claim 19, further comprising providing a voltage sensor and connecting the controller to receive a signal output from the voltage sensor.

25. A monitoring device for use in connection with devices operated from an electric power source comprising:
(a) a carbon monoxide (CO) sensor;
(b) a humidity sensor;
(c) a voltage sensor connected to the source of electric power;
(d) a controller operably connected to the CO sensor, the humidity sensor and the voltage sensor;
(e) a user interface, wherein the controller is operative to interrogate the CO sensor, the humidity sensor, and the voltage sensor for respective values of CO level, relative humidity and power source voltage and provide an indication of the values thereof at the interface.

26. The monitoring device of claim 25, wherein the controller interrogates periodically.

27. The monitoring device of claim 25, wherein the controller interrogates sequentially.

28. The monitoring device of claim 25, wherein the CO sensor, the humidity sensor, the voltage sensor, the controller and the user interface are disposed in a common enclosure.

29. The monitoring device of claim 25, wherein the user interface includes a digital readout.

30. The monitoring device defined in claim 25, wherein the controller is operative in response to receiving a predetermined value to (i) provide an alarm signal, (ii) provide a serial data output and (iii) provide a logic level output.

31. The monitoring device of claim 25, wherein the controller includes a microprocessor.
